(19) United States
(12) Patent Application Publication
(10) Pub. No.: US 2012/0233397 A1
(43) Pub. Date: Sep. 13, 2012

(54) SYSTEM AND METHOD FOR STORAGE UNIT BUILDING WHILE CATERING TO I/O OPERATIONS

(75) Inventors: Guy Keren, Haifa (IL); Benny Koren, Zichron Yakov (IL); Tzachi Perelstein, Hoshaya (IL); Yedidia Atzmony, Omer (IL); Doron Tal, Haifa (IL)

(73) Assignee: KAMINARIO TECHNOLOGIES LTD., Yokne'am (IL)

(21) Appl. No.: 13/260,677

(22) PCT Filed: Apr. 6, 2010
(86) PCT No.: PCT/IL10/00290

§ 371 Date: May 17, 2012

Related U.S. Application Data
(60) Provisional application No. 61/165,597, filed on Apr. 1, 2009.

(51) Int. Cl. G06F 12/16

(52) U.S. Cl. 711/112; 711/162; 711/E12.103

(57) ABSTRACT

Provided is a method for copying data as stored in at least one source storage entity, including copying data from a source storage entity into a destination storage entity and catering to at least one I/O operation directed toward the source storage entity during copying, the copying including reading at least one chunk of data in a predetermined order; and reading, responsive to a request, at least one relevant chunk containing data related to at least one I/O operation out of the predetermined order.

### REFERENCE TO CO-PENDING APPLICATIONS

Priority is claimed from U.S. provisional application No. 61/193,079, entitled “A Mass-Storage System Utilizing Volatile Memory Storage and Non-Volatile Storage” and filed Oct. 27, 2008.

### FIELD OF THE INVENTION

The present invention relates generally to storage systems and more particularly to catering to I/O operations accessing storage systems.

### BACKGROUND OF THE INVENTION

When reconstructing or building a storage unit, intensive I/O activity can occur concurrently. Typically, a predefined scheme for the building process is imposed, so that the building process can be controlled, monitored and run efficiently. A common approach is to retrieve data segments of a predefined size (or number of blocks) and in a predetermined sequence, so that the size of each segment is known and the sequence of retrieving the segments is also known.

The disclosures of all publications and patent documents mentioned in the specification, and of the publications and patent documents cited therein directly or indirectly, are hereby incorporated by reference.

### SUMMARY OF THE INVENTION

Certain embodiments of the present invention seek to provide copying e.g. for reconstruction with concurrent support of ongoing I/O operations during the building process. If, during the build and implementation of the sequential segment retrieval process, an I/O request is received for one or more data blocks which are mapped (or otherwise associated) with the storage unit being reconstructed, which blocks are yet to be stored on the storage unit, the sequential scheme is overridden and a segment which contains the requested blocks is promoted to the head of the queue or otherwise, e.g. in pointer-based implementations, given top priority, and is thus retrieved and stored on the storage unit ahead of segments located in front of this segment according to the original scheme. If the I/O involves blocks located in two or more different segments, the override may be implemented for each one of the two or more segments e.g. according to their internal order.

Certain embodiments of the present invention include copying a sequence of data from an intact storage module to an additional storage module which is being used not only after copying has been completed but as copying proceeds and before it has been completed. The data is served up, subdivided into “chunks”, from the intact storage module. Typically, it is more efficient for the chunks to be served up, and received in sequence i.e. in a sequence that preserves the sequence of the data. Copying may occur in order to recover data in a damaged destination device by copying the same data or data which enables computation of the same data, from an intact source device. Copying typically preserves the sequence of the data which may be a physical sequence in which the data is stored and may be a logical sequence which differs from the physical sequence. If data is stored in a physical sequence which differs from the logical sequence then typically, the relationship between the physical and logical orders is stored, e.g. in a suitable controller.

Certain embodiments of the present invention describe a method for reading and writing data in order to rebuild the image in a new host, e.g. to recover a failed solid state based storage system, to a solid state based storage system. When recovering data to a spare solid state based storage system, the data may be read from the secondary solid state based storage system which in turn reads the data from the non-volatile memory. The data might already reside in the secondary non-volatile memory but this is rare.

When rebuilding the new (spare) solid state based storage system the substantially permanent data that is to be stored in the new solid state based storage system in normal operations is typically regenerated. Thus, as part of the recovery, the spare solid state based storage system goes from one end of its storage space to the other and reads the data from the secondary system, which in turn reads that data from the non-volatile storage. Though the process may read the data block by block, for optimal utilization of the bandwidth of the network, the read operations are done in larger chunks, each comprising many blocks, where the term “block” refers to a basic unit of storage which may be employed by the storage device itself and its handlers. For example, data may be written into certain storage devices only block by block and not, for example, bit by bit.

While reading the data, I/O operations continue to be accommodated by the system. Some of these operations (reads and writes) address the data that should reside in the spare system being rebuilt. If the data is not already in the spare system being rebuilt, the spare system may do the following: If the command is a read, the system reads the entire chunk around that location. The chunk is the same chunk that would have been read in the sequential order that would have contained the data in that read operation. If the data spans more than one chunk, the spare system typically reads all the spanned chunks prior to replying. In case of a write command, the spare system first submits a read to the same locations, then reads the relevant chunks, and finally writes the data as requested.

Certain embodiments of the present invention include a method of reading and writing data from one storage source while that storage source is being loaded with the data to be read. Typically, there is a plurality of storage sources S₁ to Sₙ. Assume that one of the sources, say S₁, is being built or restored from one or many of the other storage resources S₂ through Sₙ. During the copying process from the plurality of sources to S₁, S₁ is being accessed for READ and/or WRITE purposes.

The process of copying the data to a storage resource S₁, in accordance with certain embodiments of the present invention, is as follows. S₁ is divided into sequential chunks of memory M₁ through Mₖ. These chunks may be of the same or different sizes. The chunks are then ordered e.g. as per their physical order in S₁ or as per their logical order for the host/s. A table S is provided, where for each chunk Mᵢ, S[i] points to the location in some Sⱼ where Mᵢ resides. In further embodiments one chunk Mᵢ may reside in a plurality of storage resources of type Sⱼ. An ordinarily skilled man of the art can easily transform a read from a single Sⱼ into a read operation from a plurality of Sⱼ's where the chunk Mᵢ resides.

The copying process C may be as follows. A table T of size k is provided where each entry T[i] corresponds with one of the memory chunks M₁ though Mₖ. All entries are initially marked as “not copied”. The process goes over the chunks, in the defined order, using an index INDX to denote the chunk M_{INDX} currently being copied. Initially, INDX=1 points to chunk M₁. C checks the entry T[1] in table T. If it is marked as “copied”, C advances the value INDX by 1. If the entry T[1] is marked not copied, it identifies M₁'s location in the plurality of resources S₂ through Sₙ using entry S[1] in table S, reads M₁ and writes it to the storage entity S₁. C marks the chunk M1 as “copied” in T[1] and advances the value of INDX by 1. C then turns to the next chunk pointed at by INDX, namely M₂, and repeats the process. This continues until all entries in table T have been marked as copied.

In some embodiments of the invention, there may be a plurality of typically concurrent copying processes C₁ to Cⱼ, each one responsible for a subset of the memory chunks M₁ through Mₖ. During the copy process there may be READ and WRITE operations targeted against the storage resource S₁. There may be an I/O process handling these requests, one of which may pertain to a segment of memory Q. Segment Q may be located in one of the chunks Mᵢ or it may span several chunks. If the segment Q is located in a set of chunks which was already copied to S₁, the I/O operation becomes a regular operation which requires no special attention. However, if the segment Q is located, partially or entirely, in a set of chunks which has not yet been copied, then the process Q requests the process C to copy the set of chunks that are related to the segment Q. Responsively, process C finishes copying the current chunk at INDX, creates a new temporary index INDX′ and sets it to the first chunk to be read to cater for the I/O related to segment Q. Process C then reads the sequence of memory chunks pertaining to Q using INDX′ in the same manner that it uses INDX and marks the table T accordingly. Once the copy for the subset is done, the I/O process can continue the I/O operation (READ or WRITE) and the copy process goes back to location denoted by INDX and continues until the end. In some embodiments INDX′ can be initialized as the first chunk not read as of yet. In the event that the process C reaches a location which was already copied—this is evident by the table T, C typically continues to the next not-yet-copied location, without attempting to re-copy data already copied for I/O purposes.

In some embodiments of the invention, in order to ensure that the recovery process ends, the priority of the copying process C over that of the I/O may be increased, e.g. for some predetermined duration, to get a predetermined amount or proportion of the still undone copying done.

There is thus provided, in accordance with at least one embodiment of the present invention, a method for copying data as stored in at least one source storage entities, the method comprising copying data from a source storage entity into a destination storage entity and catering to at least one I/O operation directed toward the source storage entity during copying, the copying including reading at least one chunk of data in a predetermined order; and reading, responsive to a request, at least one relevant chunk containing data related to at least one I/O operation out of the predetermined order.

Further in accordance with at least one embodiment of the present invention, the method also comprises returning to the predetermined order after reading, responsive to a request, the relevant chunks containing the data related to the operation.

Further in accordance with at least one embodiment of the present invention, the method also comprises prioritizing of catering to I/O operations vis a vis orderly copying of the storage entity and performing the copying and catering step accordingly.

Still further in accordance with at least one embodiment of the present invention, the prioritizing is determined based at least partly on I/O rate.

Additionally in accordance with at least one embodiment of the present invention, the prioritizing includes copying of the storage entity in the predetermined order if the I/O rate is lower than a threshold value.

Further in accordance with at least one embodiment of the present invention, the storage entity to be copied is volatile.

Still further in accordance with at least one embodiment of the present invention, the storage entity to be copied is non-volatile.

Further in accordance with at least one embodiment of the present invention, the source storage entity is volatile.

Additionally in accordance with at least one embodiment of the present invention, the source storage entity is non-volatile.

Further in accordance with at least one embodiment of the present invention, the chunks of data are of equal size.

Additionally in accordance with at least one embodiment of the present invention, the chunks of data each comprise at least one data block.

Still further in accordance with at least one embodiment of the present invention, the chunks of data each comprise at least one hard disk drive track.

Also provided, in accordance with at least one embodiment of the present invention, is a system for copying a storage entity from at least one source storage entity, the system comprising orderly copying apparatus for copying data from a source storage entity including reading chunks of data from the at least one source storage entity in a predetermined order; and I/O request catering apparatus for overriding the orderly copying apparatus, responsive to at least one I/O request, the overriding including reading at least one relevant chunk containing data related to the at least one I/O request, out of the predetermined order.

Further in accordance with at least one embodiment of the present invention, the I/O request catering apparatus is activated to override the orderly copying apparatus when at least one activating criterion holds and also comprising an on-line copying mode indicator operative to select one of a plurality of copying modes defining a plurality of activating criteria respectively according to which the I/O request catering apparatus is activated to override the orderly copying apparatus responsive to the plurality of copying modes having been selected respectively.

Also provided, in accordance with at least one embodiment of the present invention, is a method for managing data copying in a population of storage systems, the method comprising copying at least one first chunk from at least one source storage entity including giving a first priority to orderly copying of data vis a vis out-of-order copying of data responsive to incoming I/O requests; and copying at least one second chunk from at least one source storage entity including giving a second priority, differing from the first priority, to orderly copying of data vis a vis out-of-order copying of data responsive to incoming I/O requests.

Further in accordance with at least one embodiment of the present invention, the first priority comprises zero priority to orderly copying of data such that all copying of data is performed in an order which is determined by data spanned by incoming I/O requests rather than in a predetermined order.

Still further in accordance with at least one embodiment of the present invention, at least one individual I/O request does not result in reading at least one relevant chunk containing data related to the I/O operation out of the predetermined order, if an ongoing criterion for an adequate level of orderly copying of the storage entity is not currently met.

Additionally in accordance with at least one embodiment of the present invention, the overriding including reading less than all relevant chunks not yet copied which contain data related to received I/O requests, out of the predetermined order, wherein the less than all relevant chunks are selected using a logical combination of at least one of the following criteria:

a. chunks containing data related to I/O requests are read out of order only for high priority I/Os as defined by external inputs,

b. chunks containing data related to I/O requests are read out of order only in situations in which a predetermined criterion for background copying has already been accomplished,

c. chunks containing data related to I/O requests are read out of order only for I/O requests which span less than a single chunk,

d. chunks containing data related to I/O requests are read out of order only for I/O requests occurring at least a predetermined time interval after a previous I/O for which I/O requests were read out of order, and

e. chunks containing data related to I/O requests are read out of order only for I/O requests which have accumulated into a “queue” of at least a predetermined number of I/O requests.

Further in accordance with at least one embodiment of the present invention, the overriding including reading all relevant chunks not yet copied which contain data related to all I/O requests, out of the predetermined order.

Still further in accordance with at least one embodiment of the present invention, the reading of at least one chunk does not initiate before the reading responsive to a request.

Additionally in accordance with at least one embodiment of the present invention, the copying comprises recovering lost data.

Further in accordance with at least one embodiment of the present invention, the predetermined order comprises a physical order in which a logical stream of data is stored within the source storage entity.

Also provided is a computer program product, comprising a computer usable medium or computer readable storage medium, typically tangible, having a computer readable program code embodied therein, the computer readable program code adapted to be executed to implement any or all of the methods shown and described herein. It is appreciated that any or all of the computational steps shown and described herein may be computer-implemented. The operations in accordance with the teachings herein may be performed by a computer specially constructed for the desired purposes or by a general purpose computer specially configured for the desired purpose by a computer program stored in a computer readable storage medium.

Any suitable processor, display and input means may be used to process, display, store and accept information, including computer programs, in accordance with some or all of the teachings of the present invention, such as but not limited to a conventional personal computer processor, workstation or other programmable device or computer or electronic computing device, either general-purpose or specifically constructed, for processing; a display screen and/or printer and/or speaker for displaying; machine-readable memory such as optical disks, CDROMs, DVDs, Bluray Disk, magnetic-optical discs or other discs; RAMs, ROMs, EPROMs, EEPROMs, magnetic or optical or other cards, for storing, and keyboard or mouse for accepting. The term “process” as used above is intended to include any type of computation or manipulation or transformation of data represented as physical, e.g. electronic, phenomena which may occur or reside e.g. within registers and/or memories of a computer.

The above devices may communicate via any conventional wired or wireless digital communication means, e.g. via a wired or cellular telephone network or a computer network such as the Internet.

The apparatus of the present invention may include, according to certain embodiments of the invention, machine readable memory containing or otherwise storing a program of instructions which, when executed by the machine, implements some or all of the apparatus, methods, features and functionalities of the invention shown and described herein. Alternatively or in addition, the apparatus of the present invention may include, according to certain embodiments of the invention, a program as above which may be written in any conventional programming language, and optionally a machine for executing the program such as but not limited to a general purpose computer which may optionally be configured or activated in accordance with the teachings of the present invention. Any of the teachings incorporated herein may wherever suitable operate on signals representative of physical objects or substances.

The embodiments referred to above, and other embodiments, are described in detail in the next section.

Any trademark occurring in the text or drawings is the property of its owner and occurs herein merely to explain or illustrate one example of how an embodiment of the invention may be implemented.

Unless specifically stated otherwise, as apparent from the following discussions, it is appreciated that throughout the specification discussions, utilizing terms such as, “processing”, “computing”, “estimating”, “selecting”, “ranking”, “grading”, “calculating”, “determining”, “generating”, “reassessing”, “classifying”, “generating”, “producing”, “stereo-matching”, “registering”, “detecting”, “associating”, “superimposing”, “obtaining” or the like, refer to the action and/or processes of a computer or computing system, or processor or similar electronic computing device, that manipulate and/or transform data represented as physical, such as electronic, quantities within the computing system's registers and/or memories, into other data similarly represented as physical quantities within the computing system's memories, registers or other such information storage, transmission or display devices. The term “computer” should be broadly construed to cover any kind of electronic device with data processing capabilities, including, by way of non-limiting example, personal computers, servers, computing system, communication devices, processors (e.g. digital signal processor (DSP), microcontrollers, field programmable gate array (FPGA), application specific integrated circuit (ASIC), etc.) and other electronic computing devices.

The present invention may be described, merely for clarity, in terms of terminology specific to particular programming languages, operating systems, browsers, system versions, individual products, and the like. It will be appreciated that this terminology is intended to convey general principles of operation clearly and briefly, by way of example, and is not intended to limit the scope of the invention to any particular programming language, operating system, browser, system version, or individual product.

### BRIEF DESCRIPTION OF THE DRAWINGS

Certain embodiments of the present invention are illustrated in the following drawings:

FIG. 1 is a simplified flowchart illustration of a method for reconstructing a segment S of data, from n data sources S₁ to Sₙ, in which reconstruction is a background process which is interrupted when an I/O request arrives.

FIG. 2 is a simplified flowchart illustration of an “on-demand” method for reconstructing a segment S of data, from n data sources S₁ to Sₙ, in which there is no background reconstruction; instead, reconstruction occurs only responsive to I/O requests and, typically, only to the extent required by the incoming I/O requests.

FIG. 3 is a simplified flowchart illustration of a method for reconstructing a segment S of data, from n data sources S₁ to Sₙ, in which the identity of each chunk copied is determined according to an online decision determining whether the current task is to reconstruct the segment, in order, or to serve incoming I/Os.

FIG. 4 is a simplified flowchart illustration of a method for performing read steps, such as steps 130, 165, 250, 335, 370, in applications in which the data sources return data in units which are not identical in size to the size of the chunks used by the methods shown and described herein.

FIG. 5 is a simplified flowchart illustration of an example method for performing decision step 315 of FIG. 3.

FIGS. 6A-6B, taken together, illustrate an example of use of the method of FIG. 1.

FIGS. 7A-7B, taken together, form a diagram illustrating an example of use of the method of FIG. 2.

FIGS. 8A-8B, taken together, form a diagram illustrating an example of use of the method of FIG. 3, in which the I/O or background copying decision of step 315 is taken on the basis of I/O rate as indicated in the middle of the three branches in FIG. 5.

FIGS. 9A-9B, taken together, form a diagram illustrating an example of use of the method of FIG. 3, in which the I/O or background copying decision of step 315 is taken in accordance with a “background enforce” policy.

FIG. 10 is a simplified functional block diagram illustration of a data copying management system constructed and operative in accordance with certain embodiments of the present invention.

### DETAILED DESCRIPTION OF CERTAIN EMBODIMENTS

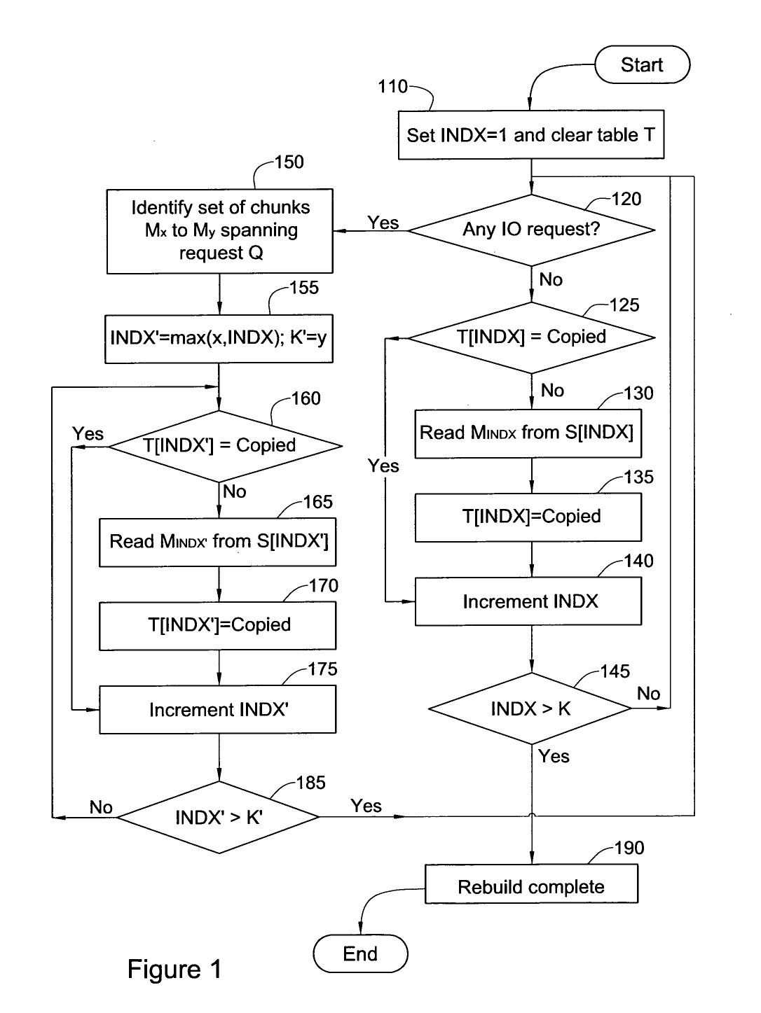

FIG. 1 is a simplified flowchart illustration of a method for reconstructing a segment S of data, from n data sources S₁ to Sₙ, in which reconstruction is a background process which is interrupted when an I/O request arrives. The method of FIG. 1 typically comprises some or all of the illustrated steps, suitably ordered e.g. as shown; more generally for all flowchart illustrations shown and described herein, the corresponding methods typically comprise some or all of the illustrated steps, suitably ordered e.g. as shown.

The size of segment S is such that the data therewithin is read chunk by chunk, in K chunks. The chunk size may be based on the media and/or network characteristics and is typically selected to be large enough to make reading out of order worthwhile, given the overhead associated with recovering data in general and out-of-order in particular, to the extent possible given the application-specific level of service which needs to be provided to I/O requests. In one embodiment, the chunk size is equal to or greater than a predefined threshold. The threshold may be fixed or dynamic. For example, the threshold may correspond to an average idle time of the storage system or of any one of the underlying storage units or any subset of the underlying storage units. In another embodiment, an initial chunk size is set and the initial chunk size is modified by a predefined optimization scheme. Each time the chunk size is modified, certain parameters of the system's performance are measured. The best or optimal chunks size is selected and is used during at least a predefined number of chunk reads. Various optimization methods are well known, and may be implemented as part of the present invention, for example, a convergence criteria may be used in the selection of an optimal chunks size.

The reading process is such that it is advantageous to read the chunks in their natural order within the n data sources i.e. first chunk 1, then chunk 2, . . . and finally chunk K. However, if an I/O request requires chunk 17, say, to be serviced, then even if the chunks are being read in order and the next chunk in line is, say, chunk 5, the method may skip to chunk 17 in order to accommodate the I/O request and only subsequently return to its background work of restoring chunks, 5, 6, 7, . . . 16, and then chunks 18, 19, . . . , again unless an additional I/O request is made and it is policy to accommodate it.

A ChunkCopied table T is provided which is initially empty and eventually indicates which chunks have or have not already been copied; this ensures that a next-in-line-to-be-copied chunk, in the background restoration process, is in fact only copied once it has been determined that that very chunk was not copied in the past in order to accommodate a past I/O request.

An index, INDX, running over the entries in the table, is initially 1. In step 120, the method checks whether any I/O request is pending which is to be accommodated even if the reconstruction process needs to be interrupted; either all I/O requests or only some may be accommodated despite the need for interruption of reconstruction, using any suitable rule. If no I/O request is waiting for accommodation, the method checks whether a currently indexed chunk has been copied, by checking whether the INDX-th entry in the table stores the value “copied” or “not copied”. If the currently indexed, i.e. INDX-th, chunk has not yet been copied, the INDX′th chunk, M_{INDX}, is read from the appropriate one (or more than one) of sources S₁ to Sₙ and the INDX-th entry in the table is set to “copied”. Unless the table index INDX has exceeded K, the method then returns to step 120.

If step 120 detects that an I/O request Q, which is to be accommodated, is waiting (yes branch of step 120), chunks Mₓ to M_{y} are identified which are required to fulfill request Q (step 150). The I/O requests a portion of storage and an inclusive set of chunks is identified. For example, if the I/O is from address 330 to 720 and the chunks each include 100 addresses, chunks 3 to 7 are identified as being required to fulfill request Q. The identified chunks are copied one after the other (steps 155-185), typically unless they have previously been copied, and typically without interruption e.g. without consideration of other I/O request that may have accumulated and without concern for the neglected background reconstruction process. Out-of-order copying takes place as per an index INDX′ which is initialized to at least x, as described in further detail below. To ensure that a previously copied requested chunk is not re-copied, the T table is checked (step 160) before copying block INDX′. Optionally, the need to access the T table for each candidate block to be copied is significantly reduced initially, for each I/O request, setting INDX′ at the maximum between x, the index of the first (lowest) requested chunk, and INDX, the index of the next to be copied chunk in the ordered, background copying, thereby obviating the need to check the T table for all blocks copied in the course of ordered, background copying.

The method then returns to step 120. Once all K chunks have been copied (step 145), the method terminates. It is appreciated that due to provision of table T and step 125, a chunk which is next in line in the background restoration process is not necessarily copied since it may be found, in step 125, to have previously been copied, presumably because it was required to accommodate a previous I/O request.

A memory segment S being recovered may for example be 100 GB (Giga Byte) in size. The chunk size may be 1 MB (Mega Byte). In this example, K=S/B=100K. A segment being read could be of any size, such as 10 Mega Bytes, which might span 10 to 12 chunks.

The term “chunk” as used herein refers to an amount of memory read from any type of storage. In HDD (hard disk drive) applications, each chunk might comprise one or more blocks or tracks, each block usually comprising 512 bytes. In RAM applications, each chunk comprises a multiplicity of bytes; since the data travels over a network, the bytes may be expressed in blocks, each of which comprises a fixed number of bytes.

The time required to read a chunk depends on the structure, characteristic and medium of the network interconnecting the storage unit being copied from and the storage unit e.g. memory being copied to, and whether the data is being read from Solid State or HDD (hard disk drive). For example, for an HDD (hard disk drive), reading 10 Megabytes might require between 10 to 80 seconds. For a solid state device, the same reading could require only about 1 msec.

Typically, once a chunk has been requested for background copying purposes, it is processed without interruption even if an I/O request arrives as it is being processed, even if the memory source is technically capable of receiving a cancellation of the request for the chunk. However, alternatively, an I/O request may be accommodated immediately even if a chunk, to be used for background copying purposes, is en route, and the remaining processing of the en route chunk (such as but not limited to requesting anew if the request is cancelled) is taken up only after accommodating the I/O request by requesting all chunks spanned thereby.

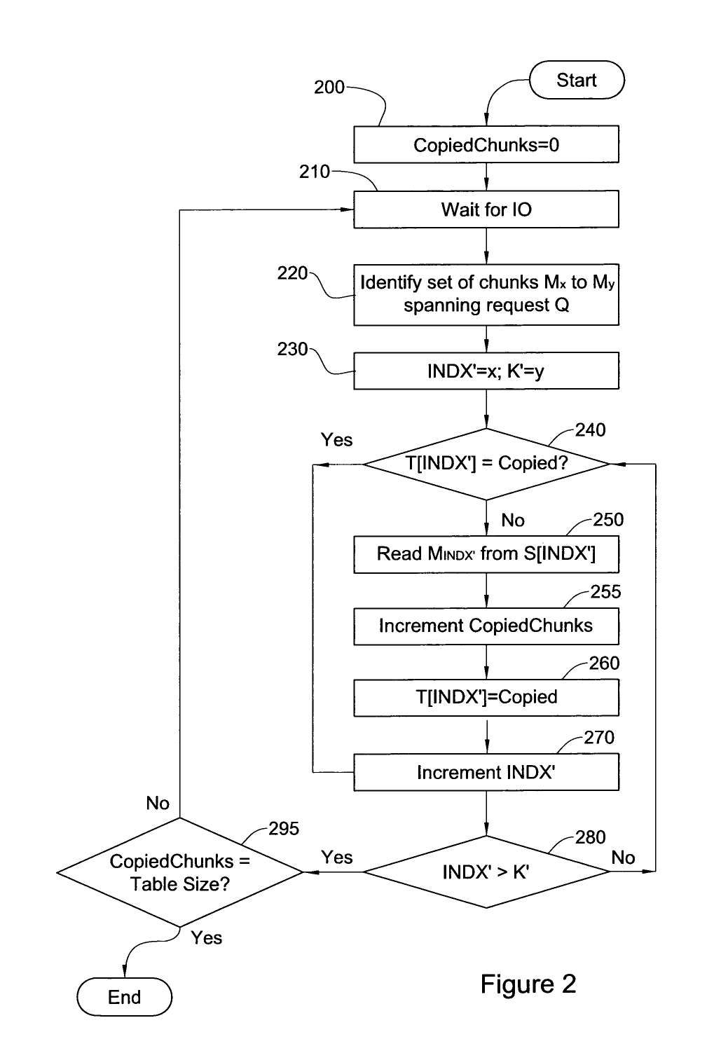

FIG. 2 is a simplified flowchart illustration of an “on-demand” method for reconstructing a segment S of data, from n data sources S₁ to S, in which there is no background reconstruction; instead, reconstruction occurs only responsive to I/O requests and, typically, only to the extent required by the incoming I/O requests. In the method of FIG. 2 background copying steps 125-150 of FIG. 1 is omitted. A CopiedChunks counter, counting the number of chunks which have already been copied, is initially set to zero (step 200). In step 210, the system waits for an I/O request. Once this is received, the spanning chunks are copied as in FIG. 1 (steps 220-250, 260-270) and the CopiedChunks counter is incremented (step 255). After all chunks requested have been supplied (step 280), the method determines whether the counter CopiedChunks has reached the parameter Table Size which holds the size of the table T i.e. the number of slots in the destination storage device. If the counter has reached this parameter, all chunks have been copied and the method is terminated. Otherwise, the system returns to waiting step 210 and continues with out-of-order copying as additional I/O requests are received, for as long as CopiedChunks remains below Table Size.

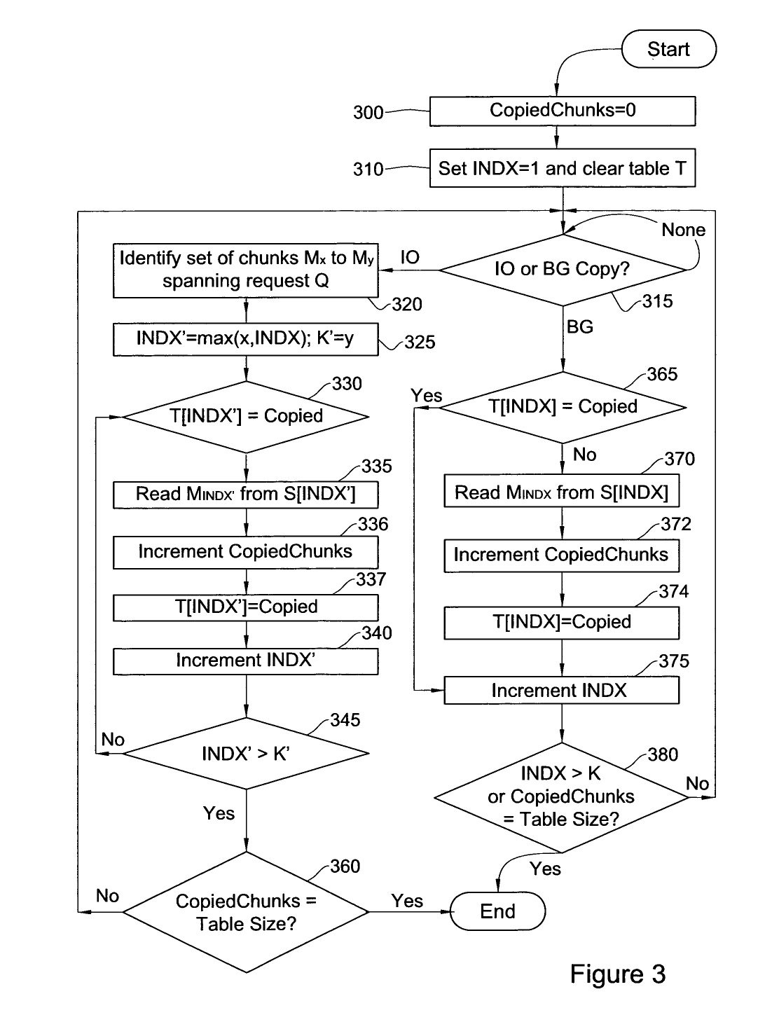

FIG. 3 is a simplified flowchart illustration of a method for reconstructing a segment S of data, from n data sources S₁ to Sₙ, in which the identity of each chunk copied is determined according to an online decision determining whether the current task is to reconstruct the segment, in order, or to serve incoming I/Os. The decision may be based on external configuration by the user giving instructions or guidelines as to which policy to invoke (e.g. as per Service Level Agreements or I/O Rate limits; and/or on fluctuating operational parameters, measured during operation, such as but not limited to the actual I/O Rate and/or the percentage of data already copied.

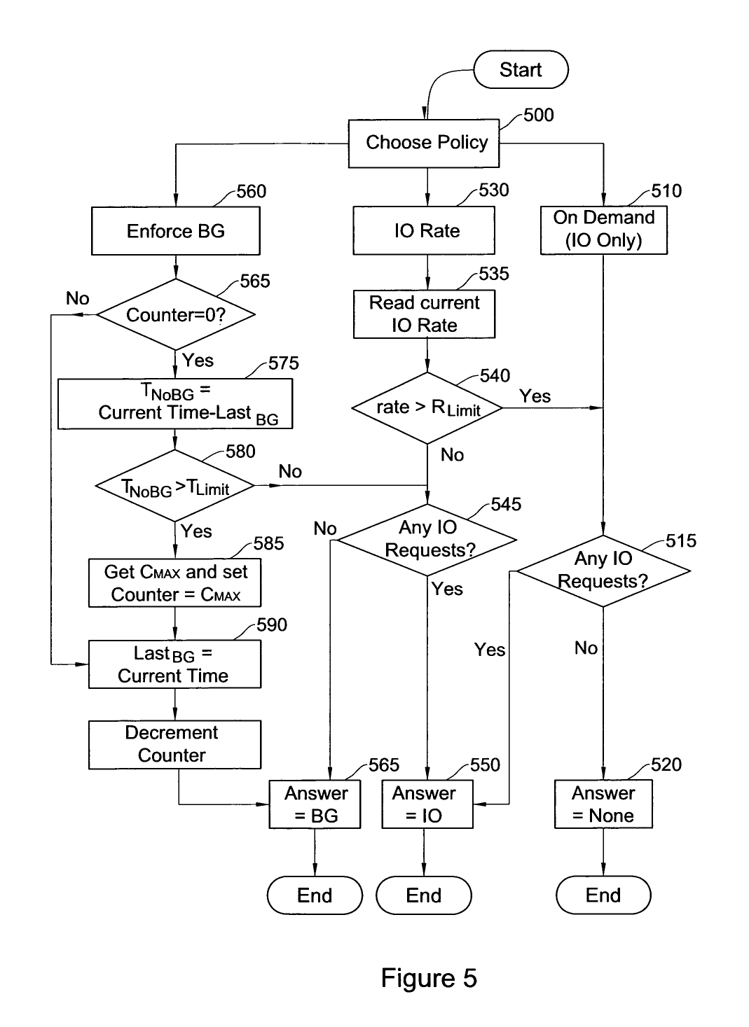

As in FIGS. 1 and 2, an initially empty chunks copied table T is provided which eventually indicates which chunks have or have not been copied and an index, INDX, running over the entries in the table, is initially 1. In decision step 315, it is decided whether the next task should be background sequential copying of chunks, or accessing specific chunks required to service an accumulated I/O request, or neither. If it is decided to access specific chunks required to service an accumulated I/O request, the method performs steps similar to I/O accommodation steps 220-270 in FIG. 2. If it is decided to begin or continue background sequential copying, the method performs steps similar to background copying steps 125-145 in FIG. 1. If neither task has been prioritized, the method simply returns to decision step 315. One suitable method for performing decision step 315 is described below with reference to FIG. 5.

Typically, as shown, a CopiedChunks counter is provided in FIG. 3, similar to FIG. 2.

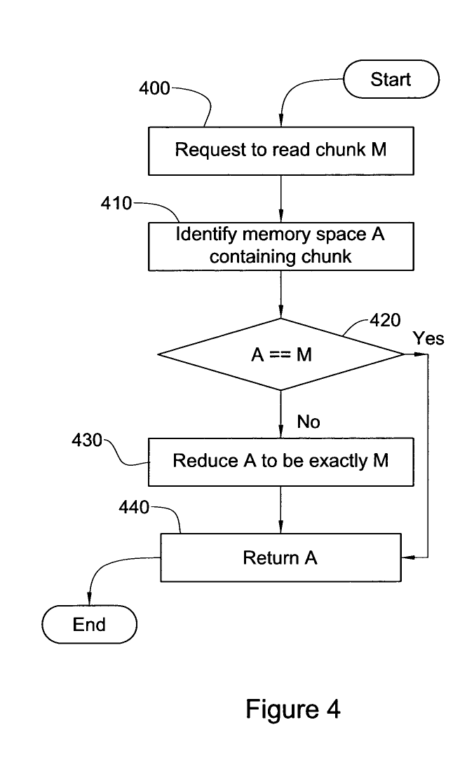

FIG. 4 is a simplified flowchart illustration of a method for performing read steps, such as steps 130, 165, 250, 335, 370, in applications in which the data sources return data in units which are not identical in size to the size of the chunks used by the methods shown and described herein. If this is the case (“no” option of step 420), either the reading step returns the minimum set of complete data source units which includes the required chunk, or, as shown in FIG. 4, the reading step reduces this minimum set (step 430) and returns only the required chunk (step 440).

FIG. 5 is a simplified flowchart illustration of an example method for performing decision step 315 of FIG. 3. As described above, decision step 315 determines whether the next task should be background sequential copying of chunks, or accessing specific chunks required to service an accumulated I/O request if any, or neither. The output of decision step 315 in these 3 instances is termed herein BG, I/O and NONE, respectively. In the method of FIG. 5, a policy is first selected (step 500) from a set of possible policies. It is appreciated that a client may select a fixed policy or a policy schedule in which different policies are used at different times of day, times of year or under different pre-determined conditions. In the illustrated example, the set of possible policies includes 3 specific policies, however, it is appreciated that there is a very wide range and number of possible policies.

The 3 policies illustrate include reverting periodically to orderly background copying (step 560), preferring accommodation of accumulated I/O requests if any (step 510—“on demand” policy as in FIG. 2), or (step 530) to prefer one or the other of the first two policies depending on relevant factors. In the example illustrated in FIG. 5, the factor determining whether to prefer periodic background copying or accommodation of accumulated I/O requests is the I/O rate (the number of I/O requests received over a selected sampling interval). Alternatively, other factors such as time of day (e.g. using the method of FIG. 1 overnight and/or on weekends and using an I/O-rate based method during the day and/or on weekdays), in isolation or in suitable logical combination, may be employed to determine whether to prefer orderly background copying or accommodation of accumulated I/O requests.

It is advantageous to provide several policies both because different clients require different policies and because a single client may require different policies at different times. For example, an e-shopping Internet site (or computerized retail outlet management system) may hold periodic “sales” such as a Christmas sale, an Easter sale and a back-to-school sale, which are normally preceded by slow periods in which there are relatively few transactions between the site and its customers e.g. e-shoppers. Just before a sale, the e-shopping site (or retail outlet) may wish to create one or more “mirrors” (copies) of data required to effect a sale, such as price data and inventory data. Therefore, enforced background policy may be appropriate, in order to ensure that the mirrors are finished by the time the sale starts, and if necessary sacrificing quality of service to the relatively few clients active prior to the sale so as to achieve quality of service to the large number of clients expected to visit the site during the sale. During each sale, I/O rate-dependent or even on-demand policy may be appropriate for restoring lost data or for completing mirrors not completed prior to the sale. Between sales, other than just before each sale, I/O rate-dependent policy may be used, however the threshold I/O rate used at these times would typically be much higher than the threshold I/O rate used for I/O rate-dependent copying occurring during a sale.

More generally, the same considerations may apply to any data-driven system which has critical periods, sometimes preceded by slow periods, and normal periods, such as (a) businesses which perform book-keeping routines including a large number of I/O requests, at the end of each financial period or (b) data driven systems having a scheduled maintenance period prior to which relevant data is copied e.g. mirrored. During critical periods, on-demand policy or I/O rate-dependent policy with a low I/O rate threshold may be suitable. In between critical periods, enforced background policy or I/O rate-dependent policy with a high I/O rate threshold may be suitable.

A particular advantage of I/O rate dependent operation is that the usefulness, or lack thereof, of short periods of time for background work vs. the distribution of intervals between I/Os, may be taken into account. It is appreciated that the I/O rate is only a rough estimate of this tradeoff and other embodiments taking this tradeoff more accurately into account are also within the scope of the present invention. For example, a learning phase may be provided in which data is collected and distribution of intervals between I/O's is determined, in order to identify the distribution of and/of frequency of intervals which are long enough to read a single block. This interval depends on the media type and/or network.

If the policy is to prefer accommodation of accumulated I/O requests if any (step 510), the method then determines whether any I/O requests are actually pending (step 515). If none are pending, the output of the method of FIG. 5 is “none”. If the policy is to periodically revert to orderly background copying, then a counter, also termed herein periodic chunks is used which indicates a number of chunks to be restored in each periodically initiated session of orderly background copying. If this counter is zero, indicating that no orderly background copying session is currently in process, the time, T_{NoBG}, which has elapsed since the last session of orderly background copying occurred (at time Last_{BG}) is computed and compared to a threshold value T_{Limit} which may have any suitable value such as for example 1 second. If the time which has elapsed exceeds the threshold value, the periodic chunks counter is set to a suitable maximum value such as for example 100 chunks and “background” is returned as the output of the method of FIG. 5 (steps 555, 595).

If the periodic chunks counter is greater than zero (“yes” option of step 565), indicating that an orderly background copying session is currently in process, the counter is decremented, the time of the most recent orderly background copying session is set to be the current time (step 590), and the output of the method of FIG. 5 is “background”.

If the policy is to prefer one or the other of the first two policies depending on the I/O rate (step 530), the I/O rate is read (step 535) and compared to a ceiling value R_{Limit} (step 540). If I/O requests are pending, or if the I/O rate exceeds the ceiling even if no I/O requests are pending, the “on demand” (only I/O) policy is used (step 515 and 520), the rationale being that with such a high rate of I/O, background copying is not efficient because it is likely to be interrupted too often to allow efficiency to be achieved. Otherwise, i.e. if the I/O rate does not exceed the ceiling and if there are no I/O requests, the method returns a “background” output.

It is appreciated that any suitable control parameter can be used to adjust the tradeoff between orderly background copying and I/O request motivated, out of order copying, such as but not limited to the following:

a. I/O Rate: the rate at which write I/O requests, or all I/O request come in. The system may for example be programmed such that, from a certain rate and upward, the system focuses on catering to the requests rather than to orderly background copying. In the present specification, the term “catering to” an I/O request for data made by a requesting entity refers to supplying the data to that entity.

b. Time since last chunk recovered: if a long time period has elapsed since orderly background copying was indulged in, the priority of background copying may be increased by a predetermined step or proportion, to ensure advancement of background copying. The priority of background copying may be decreased by the same or another predetermined step or proportion, if a large amount of or proportion of background copying seems to have already occurred and/or if indications of distress stemming from inadequate servicing of I/O requests, are received.

c. External request.

Certain of the illustrated embodiments include steps such as steps 120 in FIGS. 1 and 545 in FIG. 5 which unreservedly prefer any and all I/O requests over background. Alternatively however, these steps may be replaced with steps which differentiate between more than one class of I/O requests, the classes typically being defined by external inputs such as high-criticality and low-criticality I/O requests. More generally, a plurality of policies may be provided for a corresponding plurality of I/O request classes. For example, background copying may be preferred over catering to low-criticality I/O requests, always or at least when the I/O rate is low, whereas catering to high-criticality I/O requests may be preferred over background copying, always or at least when the I/O rate is high.

It is appreciated that many variations are possible in implementing the “enforce background” policy of FIG. 5. Generally, if a threshold amount of background copying T_{Limit} is not performed, the system reverts exclusively to background copying until a predetermined stopping criterion therefor is reached. For example, the stopping criterion may be a number of chunks to be copied, or a number of chunks to be dealt with i.e. either copied or skipped because they were previously copied out of order. A variation, “enforce copy” of the “enforce background” policy of FIG. 5 may be provided, in which if a threshold amount of copying (background or out of order), T_{Limit}, is not performed, the system reverts exclusively to background copying until a predetermined stopping criterion therefor is reached. In other words, under “enforce copy” policy, out of order copying, and not just background copying, counts toward the threshold amount of copying. The term “ensure copy” policy is used to include both “enforce copy” and “enforce background” policies and more generally any policy in which the system reverts exclusively to copying if a criterion for insufficient copying to date has been fulfilled.

It is appreciated that the CopiedChunks counter is advantageously provided in embodiments in which no orderly (background) copying is performed or in embodiments in which, for significant periods of time, no orderly (background) copying is performed. Alternatively, the CopiedChunks counter may be provided in all embodiments.

Still with reference to FIG. 5, a background enforcing policy includes forcing copying of C_{MAX} chunks in background if the amount of time which has elapsed since a chunk was last copied in background (at time T_{NoBG}) exceeds T_{Limit}. C_{MAX} may be a constant. Alternatively, C_{MAX} may be determined each time the “get C_{MAX}” step 585 is reached. C_{MAX} may be determined in accordance with a user- or system-provided function. One example of a suitable function is the inverse of the I/O rate or an increasing function thereof. Another example is that C_{MAX} may be a predetermined proportion of the number of yet-uncopied blocks, or an increasing function thereof.

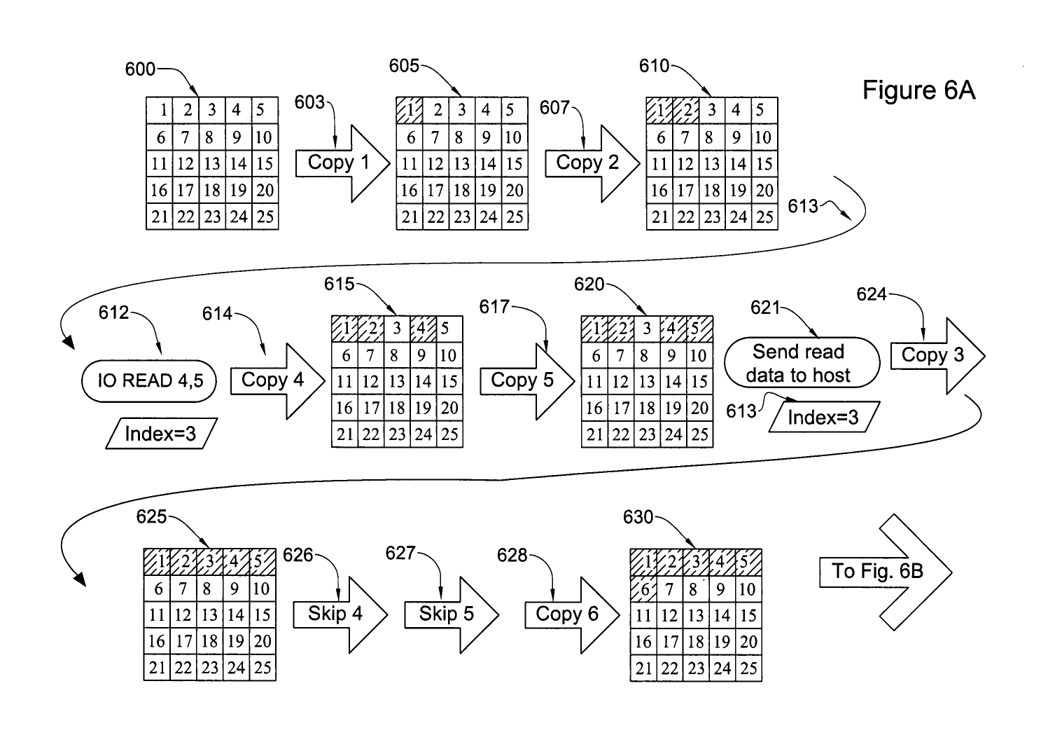

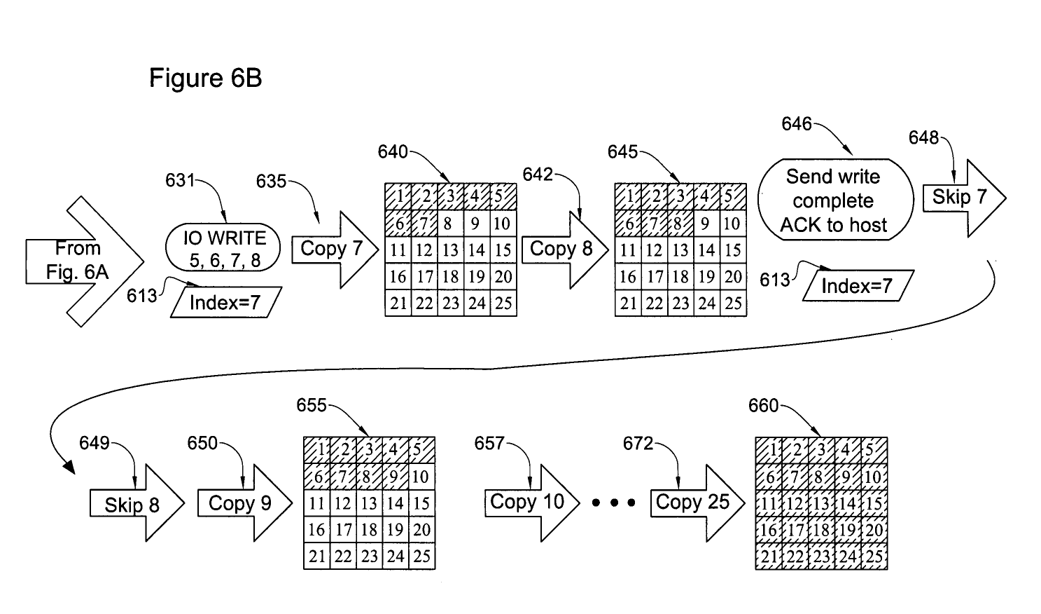

FIGS. 6A-6B, taken together, illustrate an example of use of the method of FIG. 1. A destination storage device 600 is divided into physically sequential slots 1, . . . 25 of memory, defining an order, each of which is sized to store a chunk of data which may comprise one or typically more blocks. A block is a basic unit of storage which may be employed by the storage device itself and its handlers. For example, data may be written into certain storage devices only block by block and not, for example, bit by bit. In operation 603, chunk 1 is copied from a source storage device (not shown) to slot 1 of the destination storage device 600. Slots which are unpopulated are white in FIG. 6 whereas slots which are populated with data are shaded. In operation 607, chunk 2 is copied, following which an I/O request 612 is received, pertaining to slots 4 and 5. An index (INDX) 613 is used to point to the next block (e.g. 3) which was to be copied were it not for receipt of the I/O request. In operations 614 and 617, chunks 4 and 5 are copied out of order (in the sense that at least the indexed block, 3, is passed over). The I/O request is then fulfilled and the read data is sent to the requesting host (operation 621). Background copying now re-commences, by copying the indexed chunk, 3 (operation 624) since the T table indicates that it has yet to be copied i.e. has not been out-of-order copied previously, and continuing in order, however, before copying each chunk as per the predefined order, the above-described T table is consulted to determine whether that chunk might previously have been copied, out of order. This is found to be the case for chunks 4 and 5 resulting in skipping these chunks (operations 626, 627) without copying them e.g. by incrementing the index 613. The T table indicates that chunk 6, however, has yet to be copied and it is duly copied yielding the state 630 of the destination storage device. At this point an additional I/O request is received, pertaining to chunks 5-8. The index 613 is now changed to hold value 7, the next-to-be-copied block in the background copying process. Using the above-described table T, it is determined that blocks 5 and 6 have already been copied, hence blocks 7 and 8 are now copied (operations 635 and 642). An ack message 646 is sent to the requesting host. Background copying now re-commences. Since the index 613 is 7, the seventh entry in the T table is accessed and found to have a “copied” value rather than a “not copied” value. The index 613 is incremented to 8 without copying chunk 7 (operation 648). The eighth entry in T is also found to have a “copied” value, hence is also skipped (operation 649) whereas the ninth, tenth, and . . . . Twenty-fifth entries in T are respectively found to have “not copied” values hence are copied in operations 657, . . . 672.

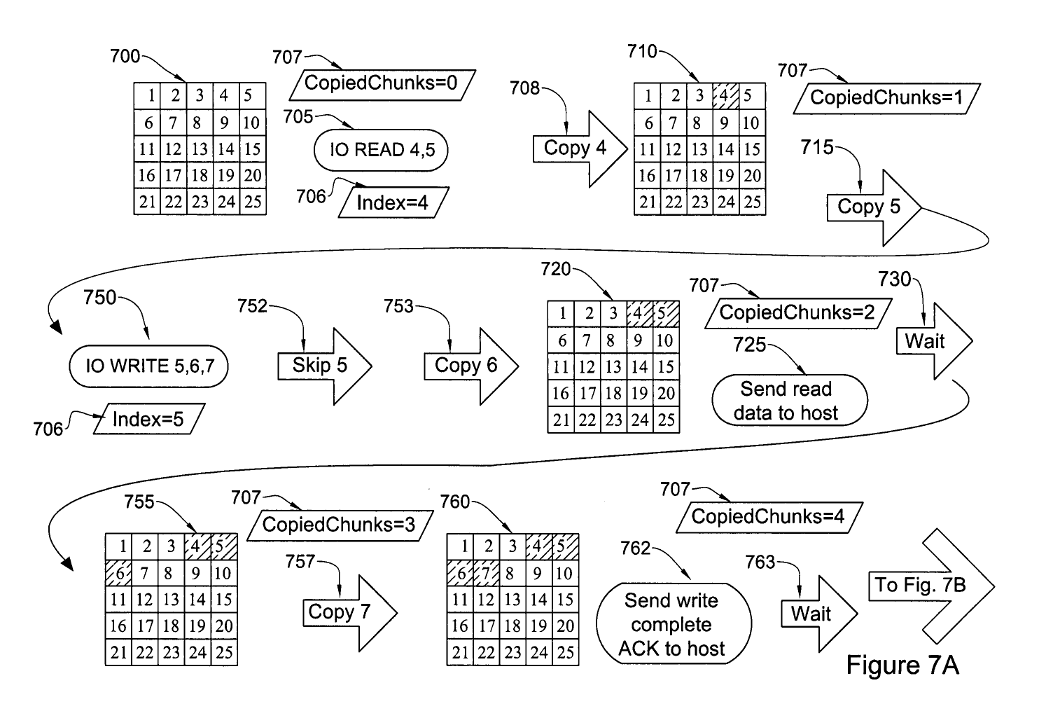

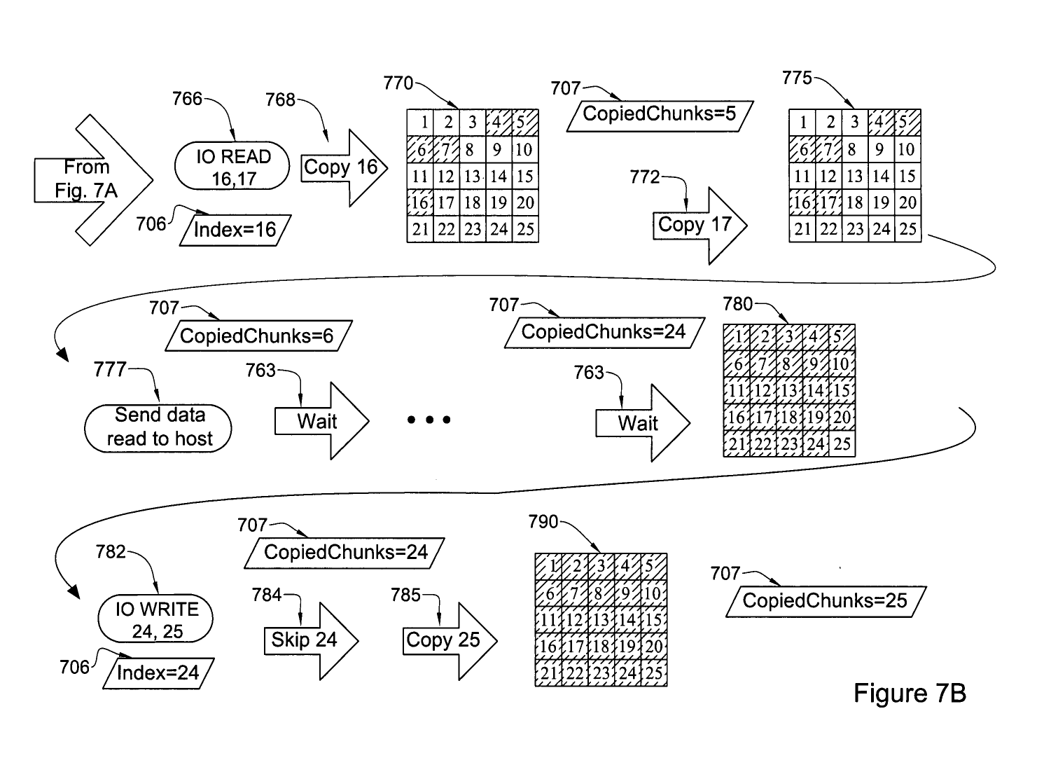

FIGS. 7A-7B, taken together, form a diagram illustrating an example of use of the method of FIG. 2. A destination storage device is initially empty (state 700). No copy operations are performed until a first I/O operation is received e.g. a read operation 705 pertaining to chunks 4 and 5. INDX (index 706) is set to 4. Chunk 4 is copied followed by chunk 5 (operations 708 and 715). Having completed the I/O request, operation 725 sends the data to the requesting host. The system then waits, say, 2200 milli-seconds, without any I/O request having been received, and then an I/O request 750 is received. As shown, this process continues for as long as ChunksCopied, a counter updated each time a chunk is copied, is still smaller than 25. As soon as ChunksCopied reaches 25, indicating that all chunks in the storage device have been copied, the method is terminated because all I/O requests now will find their spanning chunks intact in the now-full destination source device.

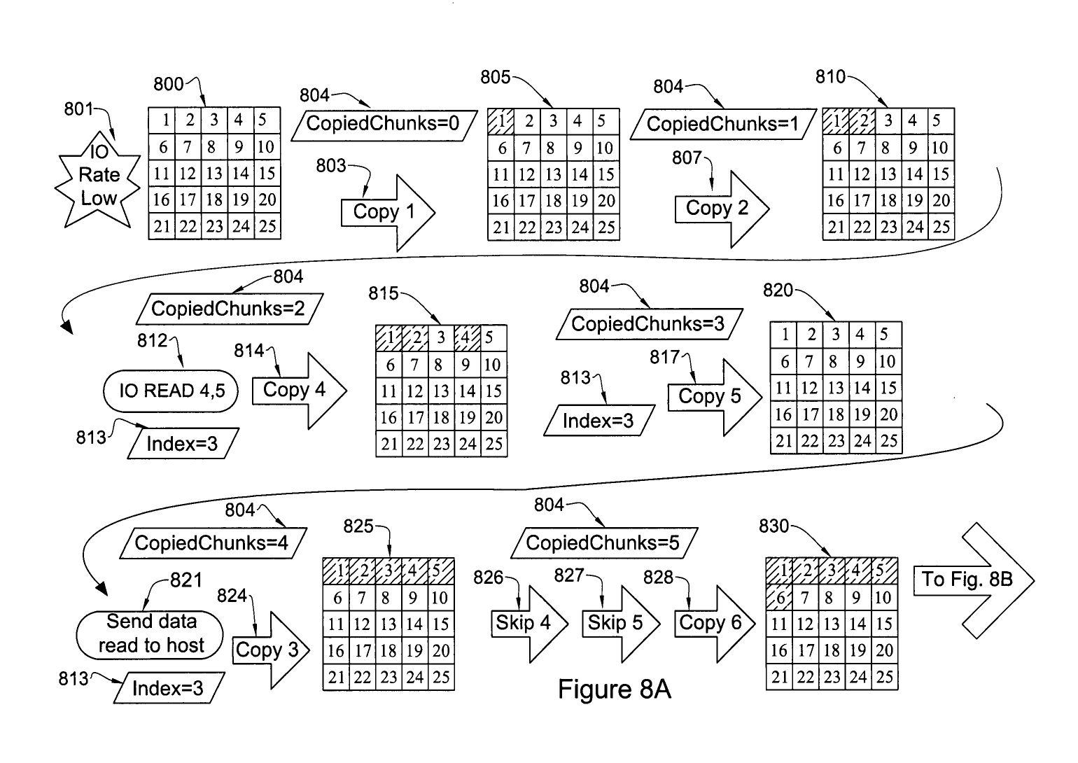

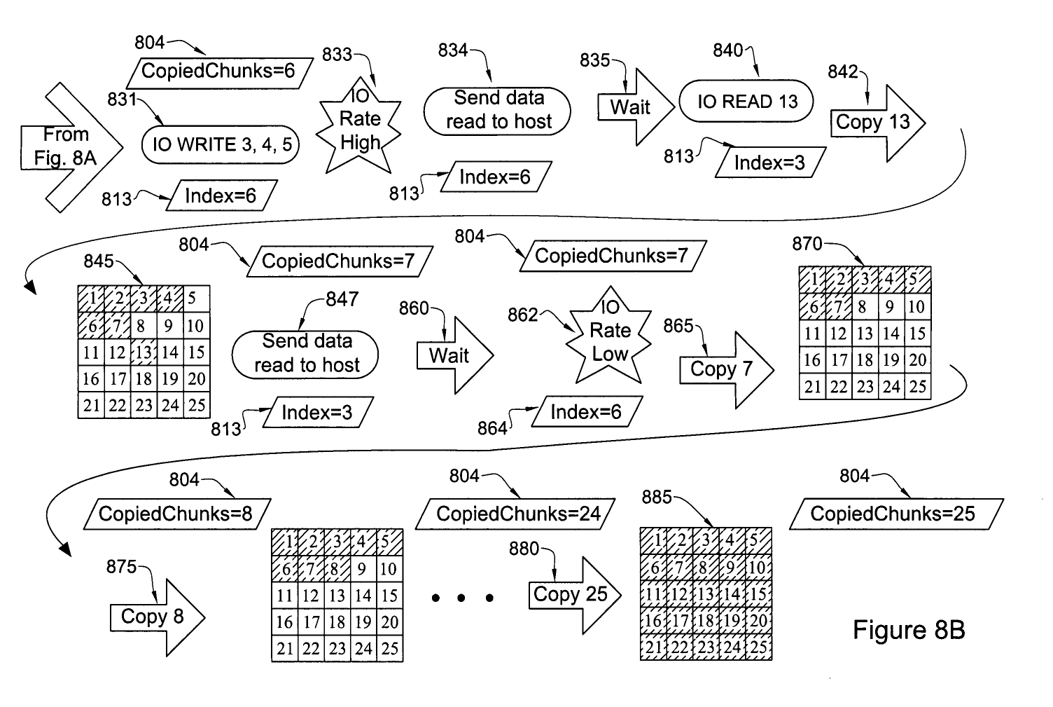

FIGS. 8A-8B, taken together, form a diagram illustrating an example of use of the method of FIG. 3, in which the I/O or background copying decision of step 315 is taken on the basis of I/O rate as indicated in the middle of the three branches in FIG. 5. As shown, the I/O rate is originally assumed to be, or computed to be, low, and therefore, background copying is initially carried out (operations 803, 807, 824, 828) other than when out of order copying is initiated (operations 814, 817) so as to serve I/O requests e.g. request 812. However, at a certain point, after one of the repeated (e.g. after each background copy operation) readings of the current I/O rate has been carried out, the system notices (operation 833) that the I/O rate is in fact higher than a predetermined threshold at which point background copying is discontinued in favor of exclusively serving I/O requests and waiting (operation 835) if no I/O requests are pending. At a subsequent point in time, after another one of the repeated readings of the current I/O rate has been carried out, the system notices (operation 862) that the I/O rate has now fallen back below the predetermined threshold at which point background copying is re-initiated as evidenced in the present example by background copying operations 865, 875, . . . 880.

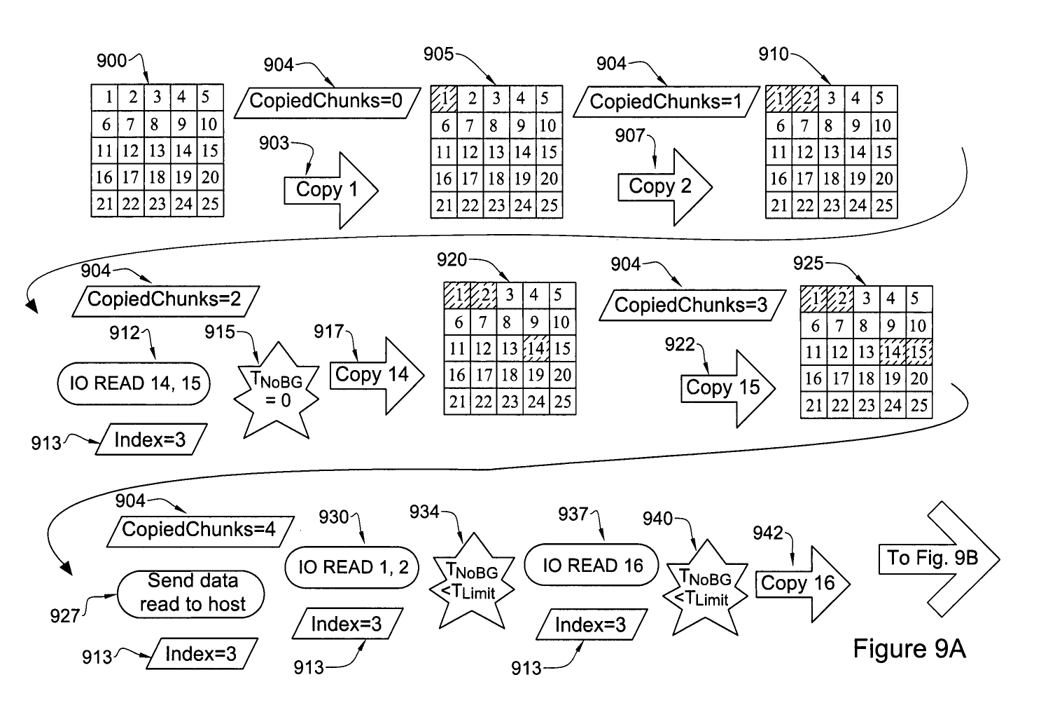

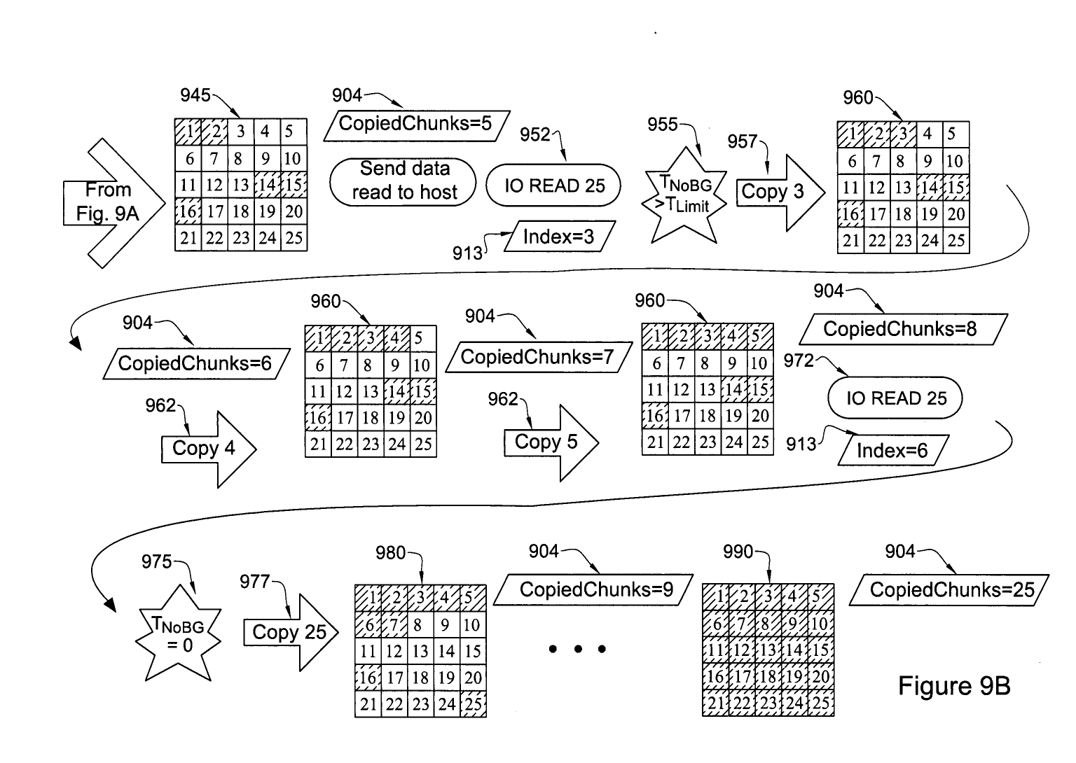

FIGS. 9A-9B, taken together, form a diagram illustrating an example of use of the method of FIG. 3, in which the I/O or background copying decision of step 315 is taken in accordance with a “background enforce” policy as shown in the leftmost of the three branches in FIG. 5, in which if a threshold amount of background copying T_{Limit} is not performed, the system reverts exclusively to background copying until a predetermined stopping criterion therefor is reached. Initially, background copying (e.g. operation 903) and out-of-order copying responsive to I/O request (e.g. operation 917) are both performed because the amount of background copying performed has not reached threshold T_{Limit} (e.g. comparison operation 940). In the illustrated embodiment, the amount of background copying performed is operationalized by a timer T_{NoBackground}, also termed herein T_{NoBG}, which triggers cessation of catering to I/O requests after it reaches a certain level i.e. threshold time period, T_{Limit}. Typically, before each I/O request is tended to, T_{NoBG} is checked against T_{Limit} to determine whether the I/O request should be catered to or should be postponed by preferring background copying.

During a certain period, many I/O operations were received one after the other, which are represented in the drawing, for simplicity, by two I/O operations 930, 937. After this period, an I/O request 952 is received but unlike previous I/O requests is not attended to immediately, because the T_{NoBG} vs. T_{Limit} check 955 determines that T_{Limit} has been reached and therefore, a predetermined number of chunks (3, in the illustrated example) are read or at least dealt with (read or skipped), in order, before any additional I/O requests are catered to.

According to certain embodiments of the present invention, I/O requests are always catered to as soon as the chunk currently being reconstructed, has been completed. However, it is appreciated that this need not be the case; alternatively I/O requests may be accommodated (catered to) only under predetermined circumstances such as but not limited to only for high priority I/O requests as defined by external inputs, only in situations in which most of the background copying has already been accomplished, only I/O requests which span less than a single chunk, only I/O requests occurring at least a predetermined time interval after the previously accommodated I/O, only I/O requests which have accumulated into a “queue” of at least a predetermined number of I/O requests, and so forth. Optionally, if a queue of I/O requests has accumulated, the I/O requests are examined to identify therewithin, “runs” of consecutive chunks, and these chunks may be copied consecutively. For example, if 3 I/O requests have accumulated, the first and earliest received spanning chunks 2-5 (the order being determined by the physical order of chunks in the storage medium), the second spanning chunks 18-19, and the third and most recently received spanning chunks 6-7, then if retrieval in accordance with the physical order in the storage medium is more cost effective than retrieval which is not in accordance with the physical order in the storage medium, chunks 2-7 may be retrieved first, followed by chunks 18-19.

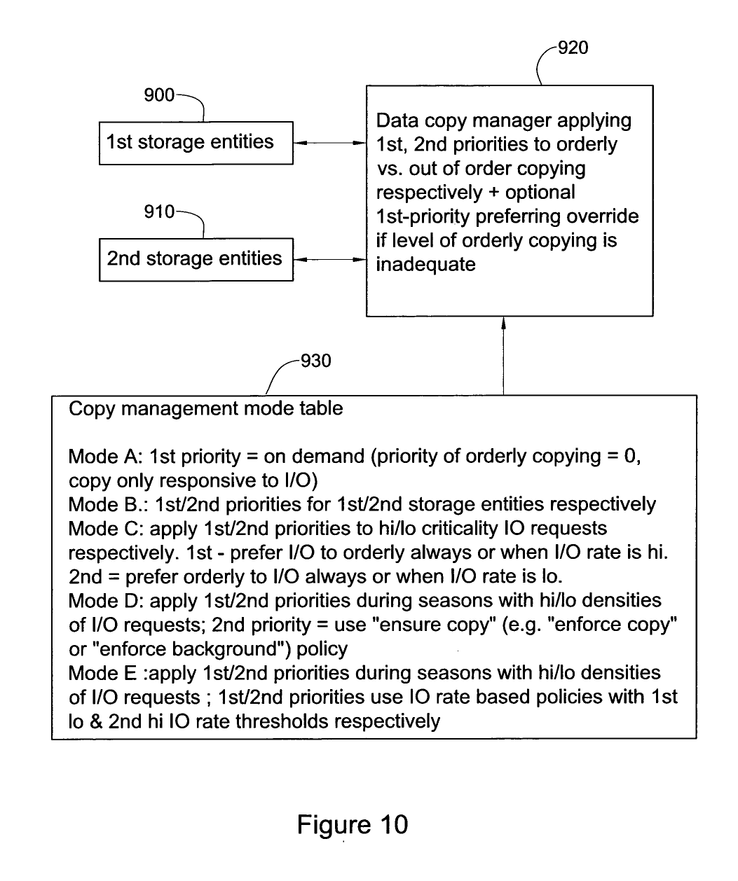

Reference is now made to FIG. 10 which is a simplified functional block diagram illustration of a data copying management system constructed and operative in accordance with certain embodiments of the present invention. The system includes a population of storage entities which may include different types of entities such as first and second storage entities 900 and 910 respectively; and a data copy manager 920 applying first and second priorities to orderly vs. out of order copying respectively and having an optional first-priority preferring override if the level of orderly copying is inadequate. The manager 920 may have one or more modes of operation e.g. as per any or all of the following modes A-E stipulated in copy management mode table 930:

A: 1st priority=on demand (priority of orderly copying is zero, copying occurs only responsive to I/O requests).

B: 1st/2nd priorities for 1st/2nd storage entities respectively.

C: apply 1st/2nd priorities to high/low criticality I/O requests respectively. The first priority scheme includes preferring I/O requests to orderly copying always or when I/O rate is high. The second priority scheme includes preferring orderly copying to catering to I/O requests always or when I/O rate is low.

D: apply 1st/2nd priorities during seasons with high/low densities of I/O requests. The 2nd priority comprises use of “ensure copy” (e.g. “enforce copy” or “enforce background”) policies as described above.

E: apply 1st/2nd priorities during seasons with high/low densities of I/O requests; 1st/2nd priorities use I/O rate based policies with 1st low and 2nd high I/O rate thresholds respectively.

A suitable method for managing data copying in a population of storage systems, using the system of FIG. 10, may comprise copying at least one first chunk from at least one source storage entity including giving a first priority to orderly copying of data vis a vis out-of-order copying of data responsive to incoming I/O requests; and copying at least one second chunk from at least one source storage entity including giving a second priority, differing from the first priority, to orderly copying of data vis a vis out-of-order copying of data responsive to incoming I/O requests.

Giving a first priority may for example comprise giving a first priority to orderly copying of data vis a vis out-of-order copying of data responsive to incoming high-criticality I/O requests and wherein the giving a second priority comprises giving a second priority to orderly copying of data vis a vis out-of-order copying of data responsive to incoming low-criticality I/O requests and wherein the first priority is higher than the second priority.

Giving a first priority may also comprise catering to high-criticality I/O requests in preference over background copying in high I/O rate periods, or always.

Giving a second priority may comprise preferring background copying over catering to low-criticality I/O requests, at least in low I/O rate periods, or always.

Giving first priority may occur during a high-I/O-request-density season and giving second priority may occur during a low-I/O-request-density season. Giving a first priority may comprise using an on-demand policy which priorities out-of-order copying exclusively. Giving second priority may comprise using an “ensure copying” policy such as an “enforce copy” policy or an “enforce background” policy.

Giving first priority may occur during a high-I/O-request-density season and may use an I/O rate based policy with a first I/O rate threshold and giving second priority may occur during a low-I/O-request-density season and may use an I/O rate based policy with a second I/O rate threshold higher than the first I/O rate threshold.

Applications of some or all of the embodiments of the present invention include but are not limited to:

a. restoring volatile memory from non-volatile memory, in which case, typically, each chunk comprises a single track in a hard disk;

b. restoring volatile memory from volatile memory; and

c. RAIDed and not RAIDed configurations of memory.

Each of the embodiments shown and described herein may be considered and termed a Solid State Storage module which may, for example, comprise a volatile memory unit combined with other functional units, such as a UPS. The term Solid State Storage module is not intended to be limited to a memory module. It is appreciated that any suitable one of the Solid State Storage modules shown and described herein may be implemented in conjunction with a wide variety of applications including but not limited to applications within the realm of Flash storage technology and applications within the realm of Volatile Memory based storage.

In addition to all aspects of the invention shown and described herein, any conventional improvement of any of the performance, cost and fault tolerance of the solid state storage modules shown and described herein, and/or of the balance between them, may be utilized.

The terms “rebuild”, “reconstruct” and “recover” are used herein generally interchangeably.

It is appreciated that software components of the present invention including programs and data may, if desired, be implemented in ROM (read only memory) form including CD-ROMs, DVDs, BluRay Disks, EPROMs and EEPROMs, or may be stored in any other suitable computer-readable medium such as but not limited to disks of various kinds, cards of various kinds and RAMs. Components described herein as software may, alternatively, be implemented wholly or partly in hardware, if desired, using conventional techniques.

Included in the scope of the present invention, inter alia, are electromagnetic signals carrying computer-readable instructions for performing any or all of the steps of any of the methods shown and described herein, in any suitable order; machine-readable instructions for performing any or all of the steps of any of the methods shown and described herein, in any suitable order; program storage devices readable by machine, tangibly embodying a program of instructions executable by the machine to perform any or all of the steps of any of the methods shown and described herein, in any suitable order; a computer program product comprising a computer useable medium having computer readable program code having embodied therein, and/or including computer readable program code for performing, any or all of the steps of any of the methods shown and described herein, in any suitable order; any technical effects brought about by any or all of the steps of any of the methods shown and described herein, when performed in any suitable order; any suitable apparatus or device or combination of such, programmed to perform, alone or in combination, any or all of the steps of any of the methods shown and described herein, in any suitable order; information storage devices or physical records, such as disks or hard drives, causing a computer or other device to be configured so as to carry out any or all of the steps of any of the methods shown and described herein, in any suitable order; a program pre-stored e.g. in memory or on an information network such as the Internet, before or after being downloaded, which embodies any or all of the steps of any of the methods shown and described herein, in any suitable order, and the method of uploading or downloading such, and a system including server/s and/or client/s for using such; and hardware which performs any or all of the steps of any of the methods shown and described herein, in any suitable order, either alone or in conjunction with software.

Features of the present invention which are described in the context of separate embodiments may also be provided in combination in a single embodiment. Conversely, features of the invention, including method steps, which are described for brevity in the context of a single embodiment or in a certain order may be provided separately or in any suitable subcombination or in a different order. “e.g.” is used herein in the sense of a specific example which is not intended to be limiting. Devices, apparatus or systems shown coupled in any of the drawings may in fact be integrated into a single platform in certain embodiments or may be coupled via any appropriate wired or wireless coupling such as but not limited to optical fiber, Ethernet, Wireless LAN, HomePNA, power line communication, cell phone, PDA, Blackberry GPRS, Satellite including GPS, or other mobile delivery.

1.-34. (canceled)

35. A method for copying data as stored in at least one source storage entity, the method comprising:
copying data from a source storage entity into a destination storage entity and catering to at least one I/O operation directed toward the source storage entity during copying, the copying comprising:
reading at least one chunk of data in a predetermined order; and
reading, responsive to a request, at least one relevant chunk containing data related to at least one I/O operation out of said predetermined order.

36. The method according to claim 35, further comprising returning to said predetermined order after reading, responsive to a request, said relevant chunks containing the data related to the operation.

37. The method according to claim 35, further comprising prioritizing of catering to I/O operations vis a vis orderly copying of the storage entity and performing said copying and catering step accordingly.

38. The method according to claim 37, wherein said prioritizing is determined based at least partly on I/O rate.

39. The method according to claim 38, wherein said prioritizing comprises copying of the storage entity in said predetermined order if the I/O rate is lower than a threshold value.

40. The method according to claim 35, wherein said storage entity to be copied is volatile.

41. The method according to claim 35, wherein said storage entity to be copied is non-volatile.

42. The method according to claim 35, wherein said source storage entity is volatile.

43. The method according to claim 35, wherein said source storage entity is non-volatile.

44. The method according to claim 35, wherein said chunks of data are of equal size.

45. The method according to claim 35, wherein said chunks of data each comprise at least one data block.

46. The method according to claim 35, wherein said chunks of data each comprise at least one hard disk drive track.

47. A system for copying a storage entity from at least one source storage entity, the system comprising:
orderly copying apparatus for copying data from a source storage entity comprising reading chunks of data from said at least one source storage entity in a predetermined order; and
I/O request catering apparatus for overriding said orderly copying apparatus, responsive to at least one I/O request, said overriding comprising reading at least one relevant chunk containing data related to said at least one I/O request, out of said predetermined order.

48. The system according to claim 47 wherein said I/O request catering apparatus is activated to override said orderly copying apparatus when at least one activating criterion holds, and further comprising an on-line copying mode indicator operative to select one of a plurality of copying modes defining a plurality of activating criteria respectively according to which said I/O request catering apparatus is activated to override said orderly copying apparatus responsive to said plurality of copying modes having been selected respectively.

49. A method for managing data copying in a population of storage systems, the method comprising:
copying at least one first chunk from at least one source storage entity including giving a first priority to orderly copying of data vis a vis out-of-order copying of data responsive to incoming I/O requests; and
copying at least one second chunk from at least one source storage entity comprising giving a second priority, differing from said first priority, to orderly copying of data vis a vis out-of-order copying of data responsive to incoming I/O requests.

50. The method according to claim 49, wherein said first priority comprises zero priority to orderly copying of data such that all copying of data is performed in an order which is determined by data spanned by incoming I/O requests rather than in a predetermined order.

51. The method according to claim 35, wherein at least one individual I/O request does not result in reading at least one relevant chunk containing data related to said I/O operation out of said predetermined order, if an ongoing criterion for an adequate level of orderly copying of the storage entity is not currently met.

52. The system according to claim 47, wherein said overriding comprises reading less than all relevant chunks not yet copied which contain data related to received I/O requests, out of said predetermined order, wherein said less than all relevant chunks are selected using a logical combination of at least one of the following criteria:
a. chunks containing data related to I/O requests are read out of order only for high priority I/Os as defined by external inputs,
b. chunks containing data related to I/O requests are read out of order only in situations in which a predetermined criterion for background copying has already been accomplished
c. chunks containing data related to I/O requests are read out of order only for I/O requests which span less than a single chunk,
d. chunks containing data related to I/O requests are read out of order only for I/O requests occurring at least a predetermined time interval after a previous I/O for which I/O requests were read out of order, and
e. chunks containing data related to I/O requests are read out of order only for I/O requests which have accumulated into a “queue” of at least a predetermined number of I/O requests.

53. The system according to claim 47, wherein said overriding comprises reading all relevant chunks not yet copied which contain data related to all I/O requests, out of said predetermined order.

54. The method according to claim 35, wherein said reading at least one chunk does not initiate before said reading responsive to a request.

55. The method according to claim 35, wherein said copying comprises recovering lost data.

56. The method according to claim 35, wherein said predetermined order comprises a physical order in which a logical stream of data is stored within the source storage entity.

57. The method according to claim 35, wherein said predetermined order comprises a logical order defining a logical stream of data including the data in the source storage entity.

58. The method according to claim 49, wherein said giving a first priority comprises giving a first priority to orderly copying of data vis a vis out-of-order copying of data responsive to incoming high-criticality I/O requests and wherein said giving a second priority comprises giving a second priority to orderly copying of data vis a vis out-of-order copying of data responsive to incoming low-criticality I/O requests and wherein said first priority is higher than said second priority.

59. The method according to claim 58, wherein said giving a first priority comprises catering to high-criticality I/O requests in preference over background copying at least in high I/O rate periods.

60. The method according to claim 58, wherein said giving a second priority comprises preferring background copying over catering to low-criticality I/O requests, at least in low I/O rate periods.

61. The method according to claim 58, wherein said giving a first priority comprises always catering to high-criticality I/O requests in preference to background copying.

62. The method according to claim 58, wherein said giving a second priority comprises always preferring background copying over catering to low-criticality I/O requests.

63. The method according to claim 49, wherein said giving first priority occurs during a high-I/O-request-density season and said giving second priority occurs during a low-I/O-request-density season, wherein said giving a first priority comprises using an on-demand policy which prioritizes out-of-order copying exclusively.

64. The method according to claim 49, wherein said giving first priority occurs during a high-I/O-request-density season and said giving second priority occurs during a low-I/O-request-density season, wherein said giving a second priority comprises using an “ensure copying” policy.

65. The method according to claim 64, wherein said “ensure copying” policy comprises an “enforce copy” policy.

66. The method according to claim 64, wherein said “ensure copying” policy comprises “enforce background” policy.

67. The method according to claim 49, wherein said giving first priority occurs during a high-I/O-request-density season and comprises using an I/O rate based policy with a first I/O rate threshold and said giving second priority occurs during a low-I/O-request-density season and comprises using an I/O rate based policy with a second I/O rate threshold higher than said first I/O rate threshold.

68. A program storage device readable by machine, tangibly embodying a program of instructions executable by the machine to perform a method for copying data as stored in at least one source storage entity, the method comprising:
copying data from a source storage entity into a destination storage entity and catering to at least one I/O operation directed toward the source storage entity during copying, the copying comprising:
reading at least one chunk of data in a predetermined order; and
reading, responsive to a request, at least one relevant chunk containing data related to at least one I/O operation out of said predetermined order.

69. A computer program product comprising a computer useable medium having computer readable program code embodied therein for copying data as stored in at least one source storage entity, the computer program product comprising:
computer readable program code for causing the computer to copy data from a source storage entity into a destination storage entity and catering to at least one I/O operation directed toward the source storage entity during copying, the copying comprising:
computer readable program code for causing the computer to read at least one chunk of data in a predetermined order; and
computer readable program code for causing the computer to read, responsive to a request, at least one relevant chunk containing data related to at least one I/O operation out of said predetermined order.

70. A program storage device readable by machine, tangibly embodying a program of instructions executable by the machine to perform a method for managing data copying in a population of storage systems, the method comprising:
copying at least one first chunk from at least one source storage entity including giving a first priority to orderly copying of data vis a vis out-of-order copying of data responsive to incoming I/O requests; and
copying at least one second chunk from at least one source storage entity including giving a second priority, differing from said first priority, to orderly copying of data vis a vis out-of-order copying of data responsive to incoming I/O requests.

71. A computer program product comprising a computer useable medium having computer readable program code embodied therein for managing data copying in a population of storage systems, the computer program product comprising:
computer readable program code for causing the computer to copy at least one first chunk from at least one source storage entity including giving a first priority to orderly copying of data vis a vis out-of-order copying of data responsive to incoming I/O requests; and
computer readable program code for causing the computer to copy at least one second chunk from at least one source storage entity including giving a second priority, differing from said first priority, to orderly copying of data vis a vis out-of-order copying of data responsive to incoming I/O requests.
